(19) United States
(12) Patent Application Publication
(10) Pub. No.: US 2025/0024010 A1
(43) Pub. Date: Jan. 16, 2025

(54) DISPLAY DEVICE, DISPLAY METHOD, AND DISPLAY PROGRAM

(71) Applicant: SONY GROUP CORPORATION, TOKYO (JP)

(72) Inventors: YOSHINORI OHASHI, TOKYO (JP); TAKAAKI YOSHIDA, TOKYO (JP)

(21) Appl. No.: 18/710,952

(22) PCT Filed: Nov. 17, 2022
(86) PCT No.: PCT/JP2022/042773

§ 371 Date: May 16, 2024

(30) Foreign Application Priority Data
Nov. 25, 2021 (JP) 2021-191092

(51) Int. Cl. H04N 13/122; H04N 13/344

(52) U.S. Cl. CPC H04N 13/122; H04N 13/344

(57) ABSTRACT

A display device (100) according to the present disclosure includes a calculation unit that calculates a displacement of a baseline serving as a reference of display processing on right and left display units (110) on the basis of information obtained from a plurality of cameras (60) installed in the vicinity of the right and left display units corresponding to a user's visual field, and a conversion unit that converts an image displayed on the display unit so as to correct the baseline displacement calculated by the calculation unit.

### FIELD

The present disclosure relates to a display device, a display method, and a display program. Specifically, this relates to control processing in image display.

### BACKGROUND

In order to implement binocular stereoscopic vision in augmented reality (AR) and virtual reality (VR) technologies and the like, a head mounted display (HMD) is used. In order to display an image without displacement in stereoscopic vision in the HMD, it is important to correct right and left parallax displacement.

As a method of detecting the parallax displacement, for example, a technology of obtaining a parallax using an in-vehicle stereo camera and correcting the parallax is known (for example, Patent Literature 1). A technology of adapting a camera image displayed on the HMD to a posture of the HMD on the basis of posture information is known (for example, Patent Literature 2).

### CITATION LIST

### Patent Literature

Patent Literature 1: JP 2017-173343 A
Patent Literature 2: WO 2019/176035 A

### SUMMARY

### Technical Problem

The HMD might include an inter pupillary distance (IPD) adjusting mechanism to assist binocular stereoscopic vision of a user wearing the HMD. However, when right and left optical systems are slid by the IPD adjusting mechanism, a slight displacement occurs in a vertical image position between right and left images of the HMD, so that binocular stereoscopic vision is not established and the image appears as a blurred image. In the HMD designed to be small and light in order to improve a wearing feeling of the user, a casing and the like is deformed by a slight external force, and the right and left images are also displaced.

In the conventional technology, it has been difficult to solve a situation in which the binocular stereoscopic vision is not established on the basis of a structure unique to the HMD as described above.

The present disclosure proposes a display device, a display method, and a display program capable of appropriately implementing binocular stereoscopic vision in the HMD.

### Solution to Problem

A display device according to one embodiment of the present disclosure includes a calculation unit that calculates a displacement of a baseline serving as a reference of display processing on right and left display units on the basis of information obtained from a plurality of cameras installed in the vicinity of the right and left display units corresponding to a user's visual field, and a conversion unit that converts an image displayed on the display unit so as to correct the baseline displacement calculated by the calculation unit.

### BRIEF DESCRIPTION OF DRAWINGS

FIG. 1 is a perspective view illustrating a structure of a display device according to an embodiment.

FIG. 2 is a perspective view illustrating a structure of an optical block according to the embodiment.

FIG. 3 is a rear view of the optical block according to the embodiment.

FIG. 4 is a plane view of the display device according to the embodiment.

FIG. 5 is a bottom view of the display device according to the embodiment.

FIG. 6 is a front view of the display device according to the embodiment.

FIG. 7 is a diagram for illustrating manual calibration according to the embodiment.

FIG. 8 is a diagram illustrating a configuration example of the display device according to the embodiment.

FIG. 9 is a flowchart illustrating a procedure of display processing according to the embodiment.

FIG. 10 is a perspective view illustrating a structure of a display device according to a first variation.

FIG. 11 is a plane view of the display device according to the first variation.

FIG. 12 is a bottom view of the display device according to the first variation.

FIG. 13 is a front view of the display device according to the first variation.

FIG. 14 is a perspective view illustrating a structure of a display device according to a second variation.

FIG. 15 is a view for illustrating a structure of a shaft according to the second variation.

FIG. 16 is a plane view of the display device according to the second variation.

FIG. 17 is a bottom view of the display device according to the second variation.

FIG. 18 is a front view of the display device according to the second variation.

FIG. 19 is a hardware configuration diagram illustrating an example of a computer that implements a function of the display device.

### DESCRIPTION OF EMBODIMENTS

Hereinafter, embodiments are described in detail with reference to the drawings. Note that, in each of the following embodiments, the same parts are denoted by the same reference signs, and redundant description is omitted.

The present disclosure is described according to the following order of items.

### 1. Embodiment

1-1. Overview of Display Processing according to Present Disclosure
1-2. Configuration of Display Device according to Embodiment
1-3. Procedure of Display Processing according to Embodiment

### 1-4. Variation of Embodiment

### 1-4-1. Example Including Two Shafts in Upper Portion

### 1-4-2. Example Including One Shaft in Upper Portion

### 1-4-3. Example of Correcting Displacement to Right and Left

### 2. Other Embodiment

3. Effect of Display Device according to Present Disclosure

### 4. Hardware Configuration

### 1. Embodiment

### (1-1. Overview of Display Processing According to Present Disclosure)

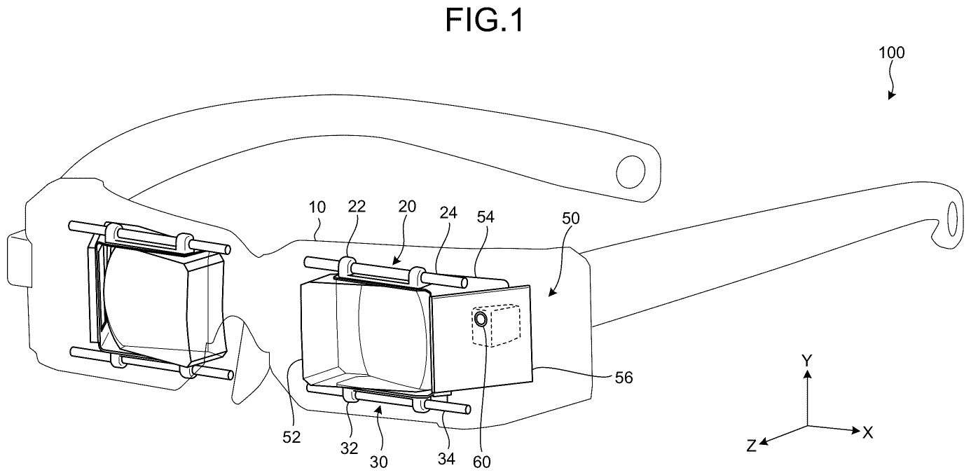

Display processing according to the present disclosure is executed by a display device 100 illustrated in FIG. 1. FIG. 1 is a perspective view illustrating a structure of the display device 100.

The display device 100 is an information processing terminal for implementing so-called VR and AR technologies and the like. In the embodiment, the display device 100 is a wearable display worn on the head of a user to be used. The display device 100 in the present disclosure is more specifically referred to as an HMD, AR glasses and the like.

In order to improve wearability and convenience of the user, not only the HMD of a conventional system of fixing to the head with a strap and the like, but also the HMD having a structure of merely hanging on the user's ear or nose like eyeglasses have been widespread. In this case, structurally, a range in which the user wearing the HMD can visually recognize an image and a virtual image (a so-called eye-box) is narrower than before. In the HDM using an optical system with a narrow eye box, particularly in a case where the HMD employs an optical see-through system, there is a case where an image cannot be correctly viewed with both eyes due to a difference in interval between right and left eyes of the user. For this reason, the HMD needs an IPD adjusting mechanism for correcting the difference in interval between the eyes.

However, when the right and left optical systems are slid by the IPD adjusting mechanism, a slight displacement occurs in vertical image position between right and left display units of the HMD, so that binocular stereoscopic vision is not established and the image appears as a blurred image. In the HMD designed to be small and light in order to improve a wearing feeling of the user, a casing and the like is deformed by a slight external force, and the right and left images are also displaced.

Particularly, in a case where the HMD employs the optical see-through system, a virtual object is drawn in a superimposing manner in a real space and the user stereoscopically view them simultaneously, so that binocular stereoscopic vision is not established only when the right and left image positions are displaced merely by several pixels.

Therefore, the display device 100 according to the present disclosure appropriately implements binocular stereoscopic vision by processing described below. Specifically, the display device 100 calculates displacement in baseline serving as a reference of display processing in right and left display units (for example, displays located in front of both eyes of the user in the eyeglass-type casing) on the basis of a stereo image imaged by a stereo camera installed in the vicinity of the right and left display units corresponding to the user's visual field. Then, the display device 100 converts the images displayed on the right and left display units so as to correct the calculated baseline displacement. In this manner, the display device 100 can implement stereoscopic vision without discomfort for the user by dynamically correcting the images output to both the eyes of the user. An overview of such processing is described with reference to FIG. 1 and subsequent drawings.

As illustrated in FIG. 1, the display device 100 includes an eyeglass-type casing 10 and a pair of right and left optical blocks 50 incorporated in the eyeglass-type casing 10. The eyeglass-type casing 10 also includes an upper shaft unit 20 and a lower shaft unit 30. Each of the upper shaft unit 20 and the lower shaft unit 30 is formed of a shaft and a bearing.

The optical block 50 includes an optical prism 52, a prism holder 54, a screen display panel 56, an upper shaft bearing 22, a lower shaft bearing 32, and a camera 60. The optical prism 52 fixed to the prism holder 54 displays an image projected from the screen display panel 56. The screen display panel 56 is, for example, an organic light emitting diode (OLED) panel. That is, the optical block 50 implements a function of displaying an image and a virtual object in the display device 100. A display mechanism (the optical prism 52, the prism holder 54, and the screen display panel 56) in the optical block 50 may be replaced with a display unit in the display device 100. The display unit in the display device 100 is, for example, a transmission-type display, and displays a superimposed object represented by computer graphics (CG) and the like, or displays an image of an image content and the like so as to be superimposed on a real space.

In the optical block 50, the upper shaft bearing 22 and the lower shaft bearing 32 slide in a right-and-left direction (an X-axis direction in the coordinate axes illustrated in FIG. 1, that is, the right-and-left direction in a case of directly facing the eyeglass-type casing 10) along the upper shaft 24 and the lower shaft 34 fixed to the eyeglass-type casing 10, so that installation sites thereof in the eyeglass-type casing 10 can be adjusted. Note that, in the following description, a Y-axis direction in the coordinate axes illustrated in FIG. 1 is referred to as a vertical direction. A Z-axis direction in the coordinate axes illustrated in FIG. 1 is referred to as a depth direction in a case of directly facing the eyeglass-type casing 10.

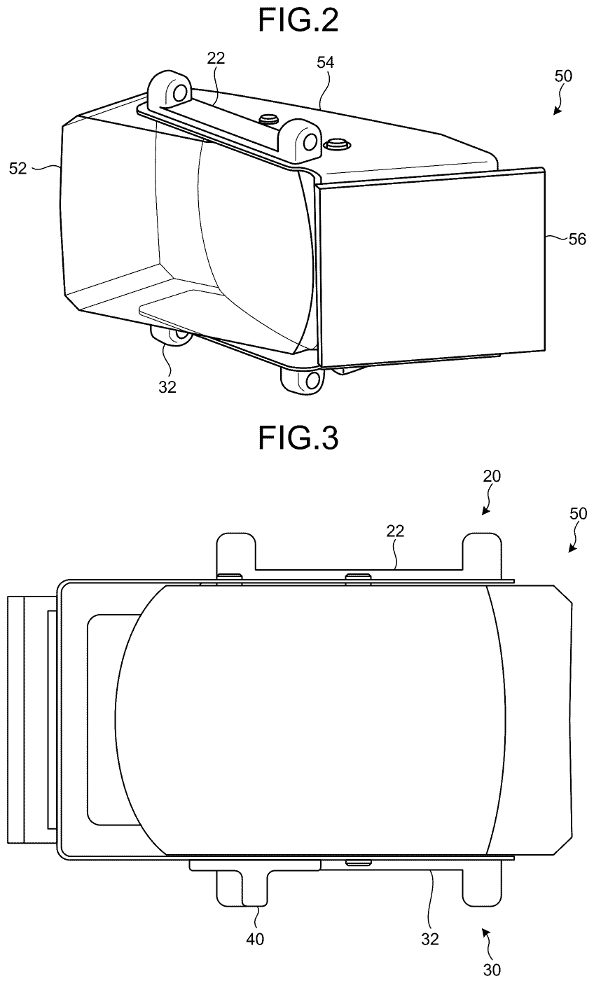

An adjusting mechanism of the optical block 50 by the shaft unit is described with reference to FIGS. 2 to 5. FIG. 2 is a perspective view illustrating a structure of the optical block 50 according to the embodiment. As illustrated in FIG. 2, the optical block 50 includes the optical prism 52 and the screen display panel 56 attached to the prism holder 54, and further has a structure in which the upper shaft bearing 22 and the lower shaft bearing 32 are attached to the prism holder 54. A shaft is inserted into each of the upper shaft bearing 22 and the lower shaft bearing 32, and the upper shaft bearing 22 and the lower shaft bearing 32 are moved to the right and left along the shaft, so that the optical block 50 is moved in the right-and-left direction.

FIG. 3 is a rear view of the optical block 50 according to the embodiment. As illustrated in FIG. 3, the optical block 50 includes an adjusting knob 40 in a lower portion thereof. The adjusting knob 40 is fixed to the prism holder 54 illustrated in FIG. 2. By moving the adjusting knob 40 in the right-and-left direction, the user can move the optical block 50 in the right-and-left direction with respect to the eyeglass-type casing 10 along the upper shaft unit 20 and the lower shaft unit 30 fixed to the eyeglass-type casing 10.

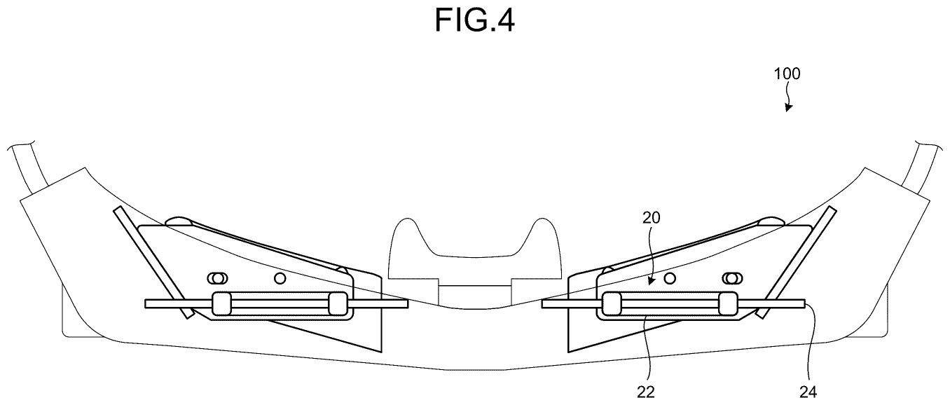

FIG. 4 is a plane view of the display device 100 according to the embodiment. As illustrated in FIG. 4, there is the upper shaft unit 20 formed of the upper shaft bearing 22 and the upper shaft 24 in an upper portion (top surface) of the display device 100. The upper shaft 24 is fixed to the eyeglass-type casing 10, and the upper shaft bearing 22 is fixed to the optical block 50.

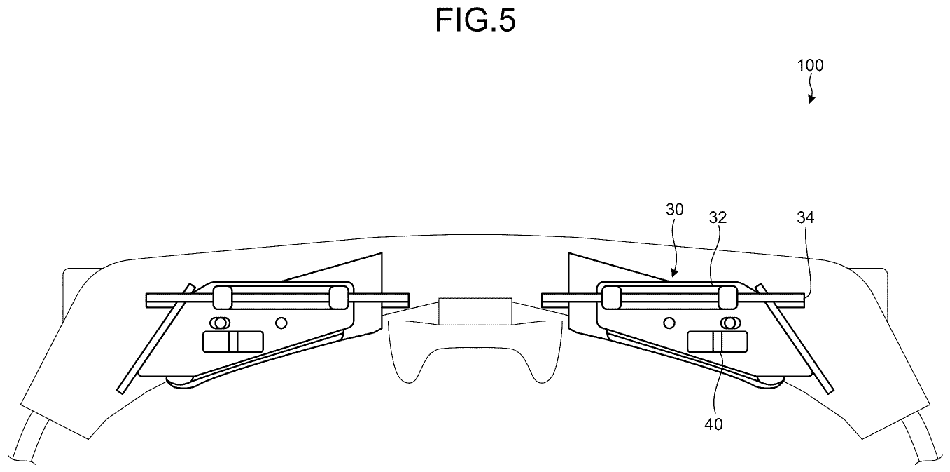

FIG. 5 is a bottom view of the display device 100 according to the embodiment. As illustrated in FIG. 5, there is the lower shaft unit 30 formed of the lower shaft bearing 32 and the lower shaft 34 in a lower portion (bottom surface) of the display device 100. The lower shaft 34 is fixed to the eyeglass-type casing 10, and the lower shaft bearing 32 is fixed to the optical block 50. The adjusting knob 40 is installed in a lower portion of the display device 100 in a position where this is manually adjustable by the user.

The user can move the optical block 50 to which the upper shaft bearing 22 and the lower shaft bearing 32 are fixed in the X-axis direction illustrated in FIG. 1 by moving the adjusting knob 40 in the right-and-left direction.

Such a mechanism is the IPD adjusting mechanism in the display device 100. That is, the optical block 50 of the display device 100 includes the display unit, the camera 60, and a moving mechanism for sliding the display unit to the right and left with respect to a direction in which this directly faces the eyeglass-type casing 10. The moving mechanism (the upper shaft unit 20 and the lower shaft unit 30) in the optical block 50 includes one shaft fixed to the upper portion and one shaft fixed to the lower portion of the display unit and a bearing fixed to the eyeglass-type casing 10. When the optical block 50 slides to the right and left (X-axis direction in FIG. 1) with respect to the direction in which this directly faces the eyeglass-type casing 10 along the shaft, the display unit and the camera 60 integrally formed with the display unit move to the right and left. In other words, the user can adjust the display unit of the display device 100 to fit an interval between the user's eyes.

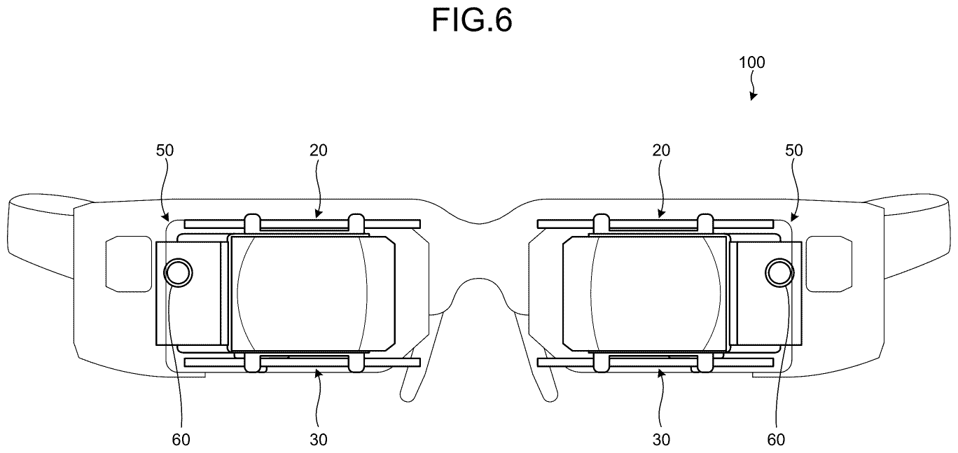

Subsequently, display processing executed by the display device 100 is described with reference to FIG. 6. FIG. 6 is a front view of the display device 100 according to the embodiment. As illustrated in FIG. 6, the display device 100 includes the camera 60 attached to each of the right and left optical blocks 50. The cameras 60 are a pair of right and left cameras having similar performance, a so-called stereo camera.

In a case where the user wears the display device 100, the cameras 60 images images in front of the display device 100, that is, in a direction coinciding with the line of sight of the user. That is, the display device 100 acquires, from the cameras 60, two images (stereo image) of an image corresponding to the line of sight of the right eye of the user and an image corresponding to the line of sight of the left eye of the user.

The display device 100 detects a feature point from the acquired stereo image. For example, the display device 100 detects the feature point of the image on the basis of a method such as corner detection for detecting a boundary and the like of an object included in the image. Specifically, the display device 100 detects a plurality of feature points (feature point group) included in the image using a method such as Harris corner detection.

The display device 100 further specifies corresponding points for the right and left feature point groups in the stereo image. As a method of searching for the corresponding points, for example, a method of detecting a common object in the stereo image using template matching and detecting the corresponding feature points can be employed.

Subsequently, the display device 100 calculates, from the corresponding feature point groups, displacement in the baseline serving as the reference of the display processing in the right and left display units. The displacement in the baseline might occur due to distortion caused by adjustment of the IPD adjusting mechanism, displacement when the user wears the display device 100, distortion of the eyeglass-type casing 10 and the like.

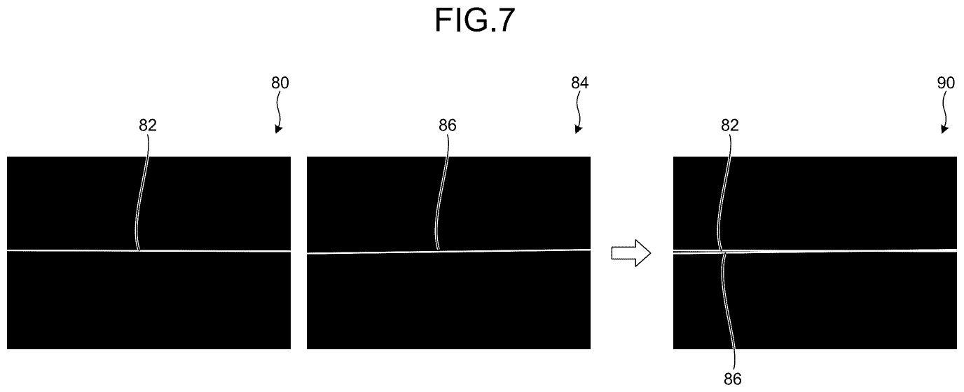

In such processing, the display device 100 may take a correction value (parameter) of the displacement between the camera 60 and the display unit manually adjusted by the user into consideration. This point is described with reference to FIG. 7. FIG. 7 is a diagram for illustrating manual calibration according to the embodiment.

An image 80 illustrated in FIG. 7 illustrates an example in which the display device 100 displays a calibration line 82 on the display unit corresponding to the user's right eye. Similarly, an image 84 illustrates an example in which the display device 100 displays a calibration line 86 on the display unit corresponding to the user's left eye. An image 90 illustrated in FIG. 7 illustrates an image when the user views the image 80 and the image 84 in a superimposed manner with both the eyes. As illustrated in FIG. 7, the user views the line 82 and the line 86 with displacement.

The line 82 and the line 86 indicate distortion caused by arrangement displacement between the display unit and the camera 60. Since the arrangement displacement between the display unit and the camera 60 occurs due to a manufacturing process or deterioration over time, it is necessary for the user to manually adjust the displacement. For example, the user performs this manual calibration every predetermined period (every several months and the like) or when the image looks blurred.

That is, the display device 100 displays lines along a screen grid such as the line 82 and the line 86 illustrated in FIG. 7. The user manually adjusts the screen display so that the right and left lines 86 and 82 overlap with each other.

Specifically, the user adjusts rotation and the displacement in the vertical direction in the image display. In a case where a degree of rotation adjusted by the user is set to a rotation matrix “Mm” and the displacement (offset) in the vertical direction is set to “Om”, the user adjusts these parameters. The display device 100 analyzes an amount manually displaced by the user and acquires these parameters. The user can perform more accurate calibration by performing three-stage processing of first adjusting in the vertical direction, adjusting the rotation, and then further adjusting in the vertical direction. Alternatively, the user can perform accurate calibration by adjusting the line 82 and the line 86 to be parallel by the rotation adjustment and then adjusting the vertical offset displayed on the screen.

Assuming that UV coordinates of the feature point detected from the image of the right camera 60 are set to PR1 (ur1, vr1), . . . , PRn (urn, vrn) (n is any natural number), and that the UV coordinates of the feature point detected from the image of the left camera 60 are set to PL1 (ul1, vl1), . . . , PLn (uln, vln), the displacement between the right and left images is represented by following formula (1).

$${\sum }_{i = 0 , j = 0}^{n} ( ( PRi * Mo + Oo ) \cdot v - PLj \cdot v ) \qquad ( 1 )$$

In order to correct the displacement between the right and left baselines, the display device 100 is only required to obtain the rotation matrix “Mo” and the vertical offset “Oo”, which are parameters for correction, so that the value of formula (1) takes a minimum value. For example, the display device 100 can employ a method of searching for an optimal solution while gradually changing the parameters “Mo” and “Oo” using a re-steep descent method or the Newton method. The display device 100 performs the above-described processing for each frame of the image to be displayed, and calculates the parameters “Mo” and “Oo”.

Next, the display device 100 converts the image output to the display unit so as to correct the calculated baseline displacement. Specifically, the display device 100 converts the image by calculating the coordinates of the output image on the basis of the rotation matrix “Mo” and the vertical offset “Oo” calculated as the parameter indicating parallax of both eyes, and a scale difference “s” between the camera image and the output image. Furthermore, in consideration of the parameters “Mm” and “Om” already obtained by the manual calibration, coordinates UV′ of the image after the conversion are represented by following formula (2).

$${UV}^{′} = UV * Mo * Mm + s * Oo + Om \qquad ( 2 )$$

The display device 100 converts the coordinates UV of the image before output into the converted coordinates UV′ by calculating formula (2) described above. Note that, the display device 100 may convert only the image corresponding to the display unit of the right eye or may convert only the image corresponding to the display unit of the left eye.

With such processing, the display device 100 can display the images in which the right and left baselines are corrected on the right and left display units (optical blocks 50). That is, even if the right and left baselines are displaced due to an influence of a lightweight frame, the display device 100 can dynamically correct the displacement, so that this can implement appropriate binocular stereoscopic vision.

### (1-2. Configuration of Display Device According to Embodiment)

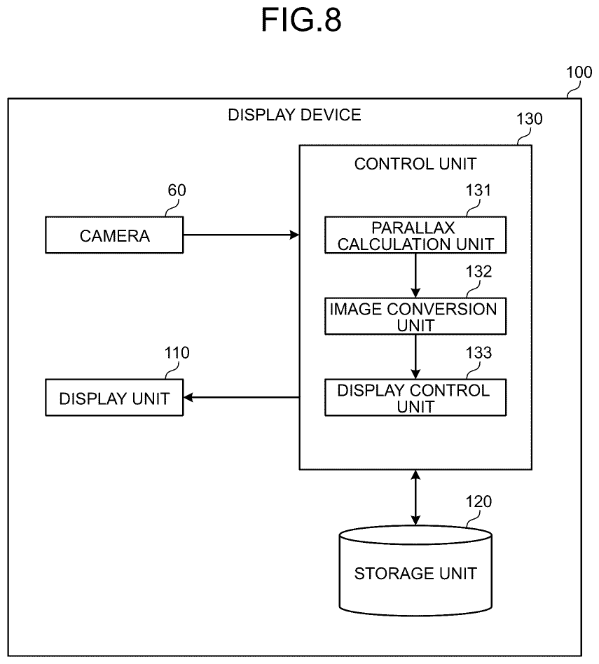

Next, a configuration of the display device according to the present disclosure is described with reference to FIG. 8. FIG. 8 is a diagram illustrating a configuration example of the display device 100 according to the embodiment of the present disclosure.

As illustrated in FIG. 8, the display device 100 includes the camera 60, a control unit 130, a storage unit 120, and a display unit 110.

Note that, although not illustrated in FIG. 8, the display device 100 may include an operation unit that receives an input from the user. For example, the operation unit includes an input device such as a touch panel and a button. For example, the operation unit may be installed at a position corresponding to a temple of the eyeglass-type casing 10. The display device 100 may also include an output unit (speaker and the like) that outputs a signal of sound and the like in an external appearance.

As described with reference to FIG. 6, the cameras 60 are the stereo camera formed integrally with the right and left optical blocks 50 to acquire the images corresponding to the line of sight of the user by imaging. Note that, the number of cameras 60 is not limited to a pair of right and left cameras, and three or more cameras may be provided. The camera 60 is formed integrally with the optical block 50 so as to face in a direction in which the head of the user faces (that is, in front of the user). On the basis of such a configuration, the camera 60 recognizes a subject located in front of the display device 100.

The storage unit 120 is implemented by, for example, a semiconductor memory element such as a RAM and a flash memory, or a storage device such as a hard disk and an optical disk. The storage unit 120 is a storage area for temporarily or permanently storing various data.

For example, the storage unit 120 may store data (for example, a display program according to the present disclosure) for the display device 100 to execute various functions. The storage unit 120 may store data for executing various applications (for example, a library), management data for managing various settings and the like. For example, the storage unit 120 stores the rotation matrix and the vertical offset, which are the correction parameters obtained by the manual calibration described above. The storage unit 120 may store the image content and the like displayed on the display unit 110.

The display unit 110 outputs and displays various types of information under the control of the display control unit 133. For example, the display unit 110 is a display for displaying a virtual object superimposed on a transmitted real space.

The control unit 130 is implemented by, for example, a central processing unit (CPU), a micro processing unit (MPU) and the like executing a program (for example, a display program according to the present disclosure) stored in the display device 100 using a random access memory (RAM) and the like as a work area. The control unit 130 is a controller, and may be implemented by, for example, an integrated circuit such as an application specific integrated circuit (ASIC) and a field programmable gate array (FPGA).

As illustrated in FIG. 8, the control unit 130 includes a parallax calculation unit 131, an image conversion unit 132, and a display control unit 133, and implements or executes a function and an action of information processing described below. Note that, an internal configuration of the control unit 130 is not limited to the configuration illustrated in FIG. 8, and may be another configuration as long as information processing to be described later is performed.

The control unit 130 may include a communication unit that transmits and receives various types of information to and from an external server and the like via a network. The communication unit is implemented by, for example, a network interface controller and the like. The communication unit is connected to the network by wire or wirelessly, and transmits and receives information to and from the external device and the like via the network. The network is implemented by, for example, a wireless communication standard or system such as Bluetooth (registered trademark), the Internet, Wi-Fi (registered trademark), ultra wide band (UWB), low power wide area (LPWA), and ELTRES (registered trademark).

On the basis of information obtained from the plurality of cameras 60 installed in the vicinity of the right and left display units 110 in the eyeglass-type casing 10, the parallax calculation unit 131 calculates the displacement in the baseline serving as the reference of the display processing in the right and left display units 110.

As described above, the parallax calculation unit 131 calculates the baseline displacement on the basis of the correspondence of the feature points in the stereo image obtained by the plurality of cameras 60. For example, the parallax calculation unit 131 calculates the baseline displacement on the basis of the correspondence of the feature points obtained by feature point detection (for example, corner detection) with respect to the object included in the stereo image.

The image conversion unit 132 converts the image displayed on the display unit 110 so as to correct the baseline displacement calculated by the parallax calculation unit 131.

Specifically, the image conversion unit 132 converts the image displayed on the display unit 110 using the rotation matrix “Mo” and the vertical offset “Oo” set so that the baseline displacement calculated by the parallax calculation unit 131 is minimized, as represented by formula (1) described above.

The image conversion unit 132 converts the image displayed on the display unit 110 on the basis of the parameters (the rotation matrix “Mm” and the vertical offset “Om”) that correct the arrangement displacement between the display unit 110 and the camera 60 manually adjusted by the user.

The display control unit 133 performs control to output the image converted by the image conversion unit 132 to each of the right and left display units 110.

### (1-3. Procedure of Display Processing According to Embodiment)

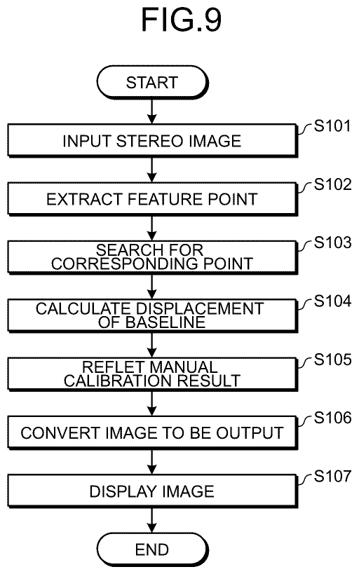

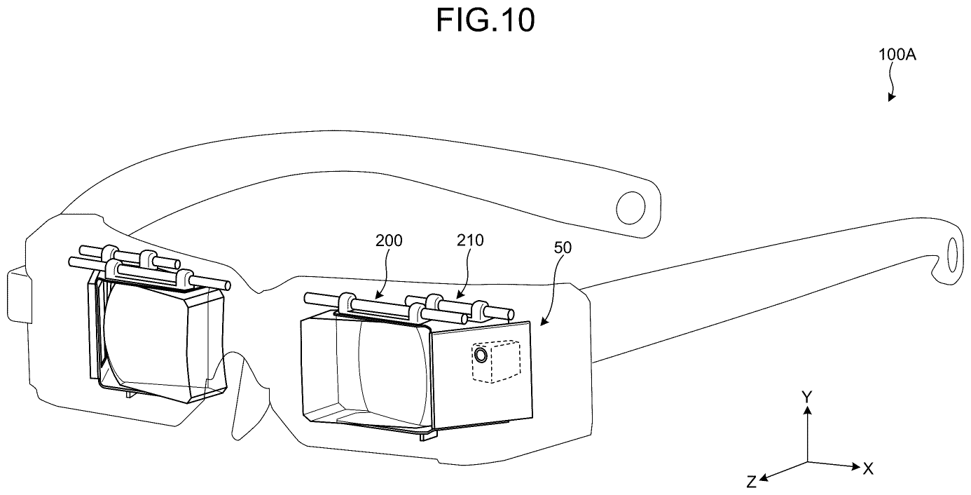

Next, a procedure of the display processing according to the embodiment is described with reference to FIG. 9. FIG. 9 is a flowchart illustrating the procedure of the display processing according to the embodiment.

First, the display device 100 receives an input of the stereo image acquired by the cameras 60 (step S101). Subsequently, the display device 100 extracts the feature points in the stereo image using the method such as the corner detection (step S102).

Subsequently, the display device 100 searches for the corresponding points in the feature point group extracted from each of stereo image (step S103). Then, the display device 100 calculates the baseline displacement in the right and left images using formula (1) described above (step S104).

The display device 100 further acquires a manual calibration result (correction parameter) performed by the user in advance, and reflects the result (step S105). Then, the display device 100 substitutes each parameter obtained at steps S103 and S104 into formula (2) described above, and converts the image to be output (step S106).

Then, the display device 100 outputs the converted image to the display unit 110 to display the image on the display unit 110 (step S107). The display device 100 repeats a series of processing for each frame of the image to be displayed.

### (1-4. Variation of Embodiment)

### (1-4-1. Example Including Two Shafts in Upper Portion)

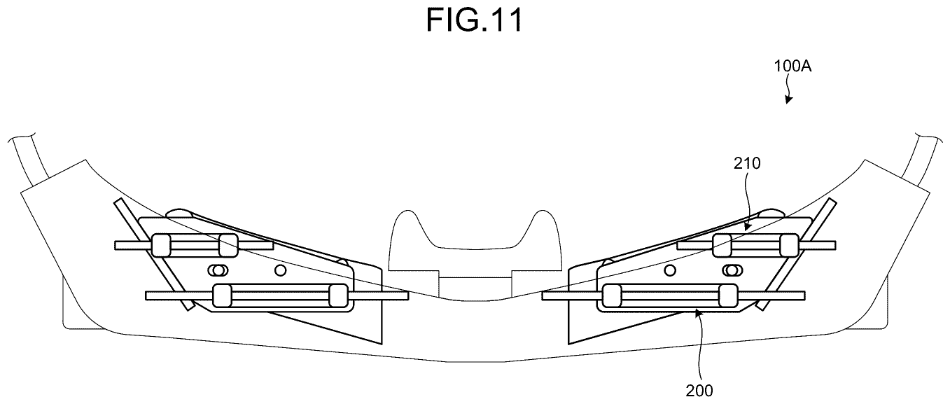

The display device 100 according to the embodiment may be accompanied by various variations described below. FIG. 10 is a perspective view illustrating a structure of a display device 100A according to a first variation.

As illustrated in FIG. 10, the display device 100A does not include one shaft in the upper portion and one shaft in the lower portion of the optical block 50, but includes two shaft units of a shaft unit 200 and a shaft unit 210 in the upper portion of the optical block 50.

FIG. 11 is a plane view of the display device 100A according to the first variation. As illustrated in FIG. 11, two shaft units 200 and 210 are attached to an upper portion of the display device 100A for one optical block 50.

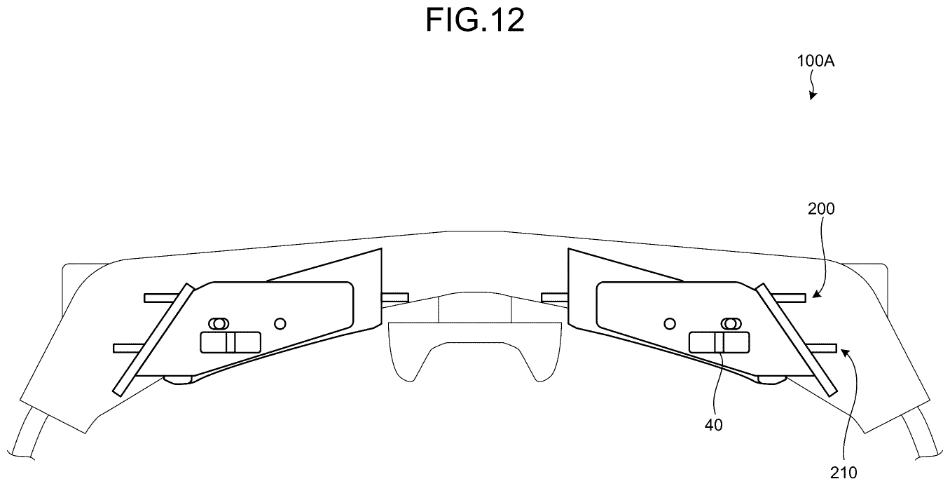

FIG. 12 is a bottom view of the display device 100A according to the first variation. As illustrated in FIG. 12, there is no shaft in a lower portion of the display device 100A, and only the adjusting knob 40 is arranged.

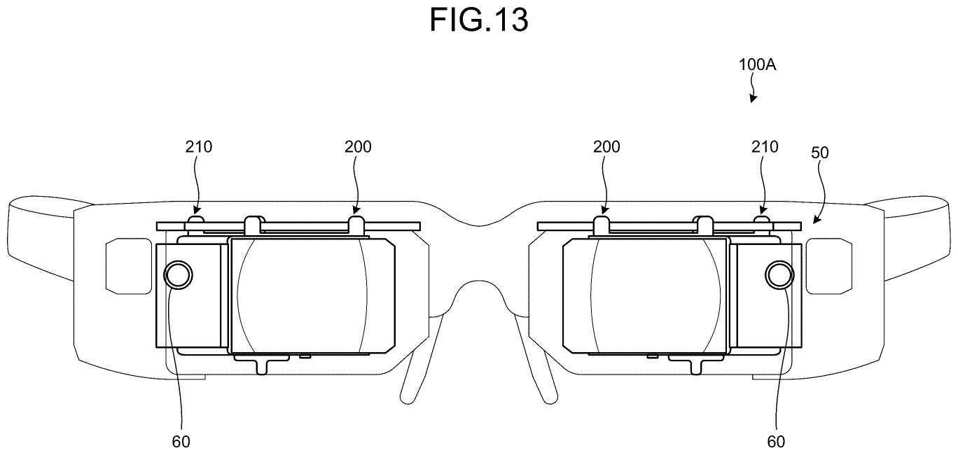

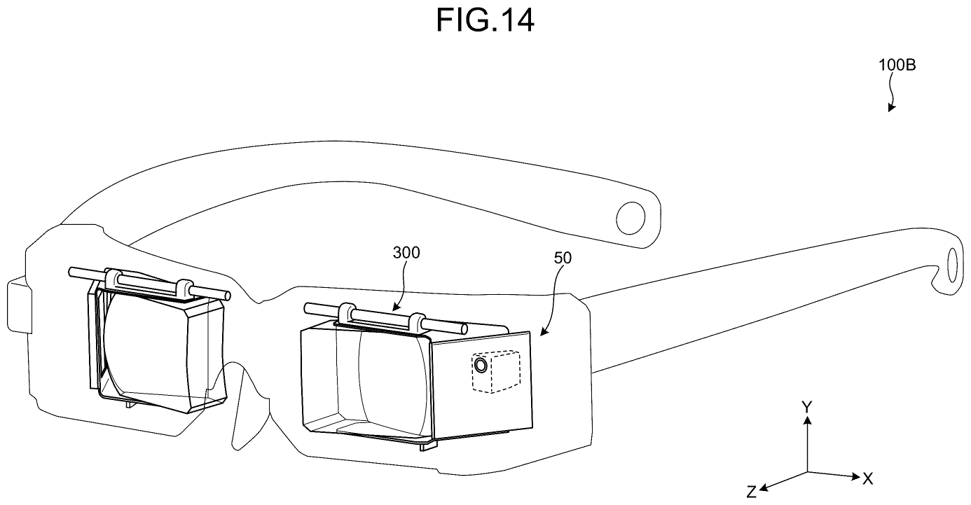

FIG. 13 is a front view of the display device 100A according to the first variation. As illustrated in FIG. 13, there is no shaft in the lower portion of the display device 100A and the shaft units 200 and 210 are arranged in the upper portion of the camera 60.

In this manner, the moving mechanism of the optical block 50 in the display device 100A includes the two shaft units 200 and 210 attached to the upper portion of the display unit. In such configuration, when the bearing of the shaft unit 200 and the bearing of the shaft unit 210 slide to the right and left with respect to the direction in which they directly face the eyeglass-type casing 10, the display unit and the camera 60 integrally formed with the display unit move to the right and left.

According to the structure of the display device 100A, since there is no mechanism unit on a lower side of the prism, visibility in a lower side vision of the user is improved.

### (1-4-2. Example Including One Shaft in Upper Portion)

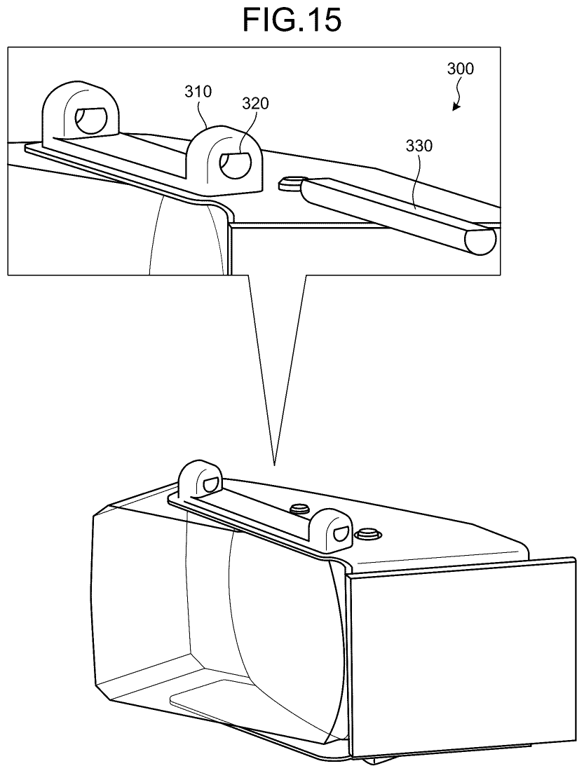

The display device 100 may include only one shaft in the upper portion. In a case of one shaft, it is desirable that there is a mechanism for preventing rotation accompanying the movement of the optical block 50. Such example is described with reference to FIGS. 14 to 18.

FIG. 14 is a perspective view illustrating a structure of a display device 100B according to a second variation. As illustrated in FIG. 14, the display device 100B includes only one shaft unit 300 in the upper portion of the optical block 50.

FIG. 15 is a view for illustrating a structure of the shaft unit 300 according to the second variation. The shaft unit 300 includes a bearing 310 and a shaft 330. As illustrated in FIG. 15, in the bearing 310, a hole through which the shaft 330 passes is notched to have a detent shape 320. The shaft 330 has a shape conforming to the detent shape 320. With this mechanism, the shaft unit 300 prevents the optical block 50 from rotating about the X-axis illustrated in FIG. 14 when moved.

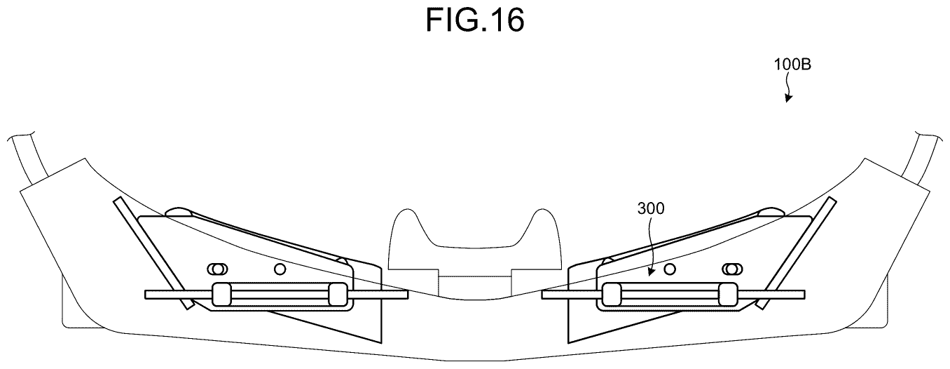

FIG. 16 is a plane view of the display device 100B according to the second variation. As illustrated in FIG. 16, one shaft unit 300 is attached to an upper portion of the display device 100B for one optical block 50.

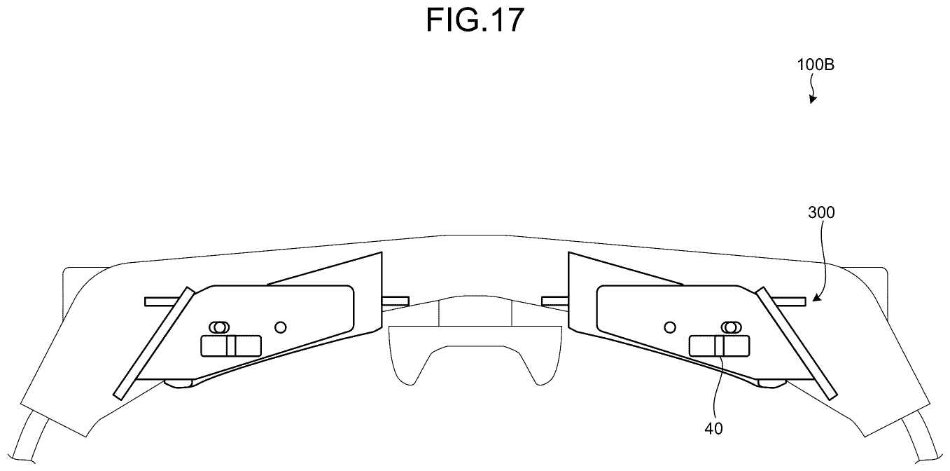

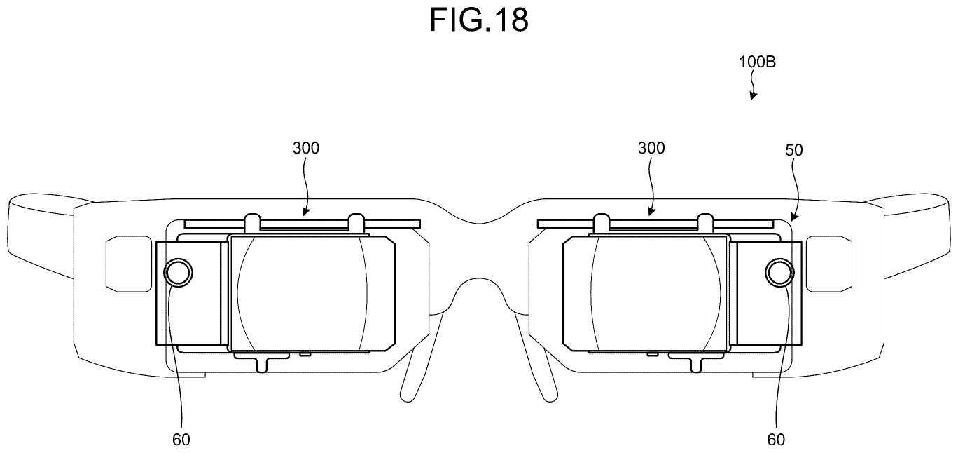

FIG. 17 is a bottom view of the display device 100B according to the second variation. As illustrated in FIG. 17, there is no shaft in the lower portion of the display device 100B, and only the adjusting knob 40 is arranged.

FIG. 18 is a front view of the display device 100B according to the second variation. As illustrated in FIG. 18, there is no shaft in the lower portion of the display device 100B and the shaft unit 300 is arranged in the upper portion of the camera 60.

In this manner, the moving mechanism of the optical block 50 in the display device 100B includes one shaft unit 300 attached to the upper portion of the display unit. In the shaft unit 300, when the bearing 310 slides to the right and left with respect to the direction in which this directly faces the eyeglass-type casing 10 along the shaft 330 fixed to the eyeglass-type casing 10, the display unit and the camera 60 integrally formed with the display unit move to the right and left. The shaft unit 300 includes a mechanism that suppresses the rotation about the right-and-left moving direction.

According to the structure of the display device 100B, since there is no mechanism unit on a lower side of the prism, visibility in a lower side vision of the user is improved. Since the display device 100B has a compact design with few components, an entire appearance is light, and the design is improved.

### (1-4-3. Example of Correcting Displacement to Right and Left)

In the above-described embodiment, an example is described in which the display device 100 adjusts the rotation of the image and the vertical offset in the display corresponding to both the eyes. Here, the display device 100 may further correct the displacement in the right-and-left direction.

In this case, in calculation processing, the display device 100 selects a feature point located at a sufficiently far place (for example, five meters or more) from the feature point groups detected in the right and left images. Among the selected feature points, UV coordinates of the feature point in the right camera 60 are set to PR1 (ur1, vr1), . . . , PRn (urn, vrn), and UV coordinates of the feature point in the left camera 60 are set to PL1 (ul1, vl1), . . . , PLn (uln, vln). The display device 100 calculates a difference “Δvm” between the right and left feature points. Such calculation is represented by formula (3) described above.

$$Δ vm = vlm - vrm \qquad ( 3 )$$

Then, in order to correct the calculated value of Δvm, in a case where a scale difference between the camera image and the output image is set to “s”, the display device 100 shifts the output of the image corresponding to the left eye to the right by “s*Δvm”. By this, the display device 100 can correct not only the vertical displacement but also the displacement in the right-and-left direction.

Note that, the display device 100 may shift the left-eye image output to the right by “(s*Δvm)/2” and shift the right-eye image output to the left by “(s*Δvm)/2” instead of shifting only the left-eye image.

The display device 100 may select a plurality of feature points located at sufficiently far places, obtain an average value of Δvm, and shift the output image in the right-and-left direction on the basis of the average value.

As described above, the display device 100 can calculate the difference between the coordinates of the corresponding feature points in the stereo image obtained by the plurality of cameras 60, and translate the image displayed on the display unit 110 to either the right or left on the basis of the difference between the coordinates.

By such processing, the display device 100 can also dynamically correct the displacement in the right-and-left direction, so that more appropriate binocular stereoscopic vision can be implemented.

### 2. Other Embodiment

The processing according to each embodiment described above may be performed in various different modes other than each embodiment described above.

For example, in the above-described embodiment, the configuration example in which the control unit 130 of the display device 100 is incorporated in the eyeglass-type casing 10 is described. However, the control unit 130 may be arranged outside the eyeglass-type casing 10. For example, the control unit 130 itself of the display device 100 may be a smartphone, a tablet terminal, a personal computer (PC) and the like, and may be connected to the eyeglass-type casing 10 that performs display processing by wire or wirelessly.

The display device 100 may be a video see-through HMD or a retinal projection HMD in addition to the optical see-through HMD. In the embodiment, an example in which the display device 100 is formed of the eyeglass-type casing 10 is described, but the casing of the display device 100 is not limited thereto, and may have a shape such as goggles or a helmet. The casing is not necessarily integrally and inseparably shaped, and the display device 100 may be implemented in a shape in which the display unit is attached to the right and left of existing eyeglasses, for example.

Among the processing described in the above-described embodiments, an entire or a part of the processing described as being performed automatically can be performed manually, or an entire or a part of the processing described as being performed manually can be performed automatically by a known method. The procedure, specific name, and information including various data and parameters illustrated in the document and the drawings can be optionally changed unless otherwise specified. For example, the various types of information illustrated in each drawing are not limited to the illustrated information.

Each component of each device illustrated in the drawings is functionally conceptual, and is not necessarily physically configured as illustrated in the drawings. That is, a specific form of distribution and integration of each device is not limited to the illustrated form, and an entire or a part thereof can be functionally or physically distributed and integrated in any unit according to various loads, usage conditions and the like.

The above-described embodiments and variations can be appropriately combined within a range in which the processing contents do not contradict each other.

The effects described in the present specification are merely examples and are not limited, and there may be other effects.

(3. Effect of Display Device according to Present Disclosure)

As described above, the display device (the display device 100 in the embodiment) according to the present disclosure includes the calculation unit (the parallax calculation unit 131 in the embodiment) and the conversion unit (the image conversion unit 132 in the embodiment). On the basis of information obtained from a plurality of cameras installed in the vicinity of the right and left display units corresponding to the user's visual field, the calculation unit calculates the displacement in the baseline serving as the reference of the display processing in the right and left display units. The conversion unit converts the image displayed on the display unit so as to correct the baseline displacement calculated by the calculation unit.

In this manner, the display device dynamically corrects the right-and-left parallax by correcting the baseline in the right and left display units on the basis of the images acquired from the cameras. By this, the display device can implement appropriate binocular stereoscopic vision.

The calculation unit calculates the baseline displacement on the basis of the correspondence of the feature points in the stereo image obtained by a plurality of cameras.

In this manner, the display device can accurately calculate the baseline displacement by associating the feature points in the images.

The calculation unit calculates the baseline displacement on the basis of the correspondence of the feature points obtained by the feature point detection with respect to the object included in the stereo image.

In this manner, the display device can accurately calculate the baseline displacement by associating the feature points in the stereo image by feature point detection such as corner detection.

The conversion unit converts the image displayed on the display unit using the rotation matrix and the vertical offset set so that the baseline displacement calculated by the calculation unit is minimized.

In this manner, the display device can accurately correct the baseline of each of the right and left images by obtaining the parameter that minimizes the displacement and converting the image.

The conversion unit converts the image displayed on the display unit on the basis of the parameter with which the arrangement displacement between the display unit and the camera is corrected.

In this manner, the display device can more accurately correct the structural displacement that is difficult to be handled in information processing by using the parameter based on the manual calibration by the user.

The display device further includes the output unit (the display control unit 133 in the embodiment) that outputs the image converted by the conversion unit to each of the right and left display units.

In this manner, the display device can implement binocular stereoscopic vision of the user without displacement by outputting the converted image.

The display device further includes the optical block (the optical block 50 in the embodiment) including the display unit, the camera, and the moving mechanism (each shaft unit in the embodiment) for sliding the display unit to the right and left with respect to the direction in which this directly faces the casing, and the casing (the eyeglass-type casing 10 in the embodiment) to which the optical block is attached.

In this manner, the display device is configured as a integral-type HMD including the casing and the optical block, so that it is possible to complete up to the correction processing in a stand-alone manner.

The moving mechanism includes one shaft fixed to each of an upper portion and a lower portion of the casing, and the bearing corresponding to the shaft fixed to an upper portion and a lower portion of the display unit, and the bearing slides to the right and left with respect to the direction in which the bearing directly faces the casing, so that the display unit and the camera integrally formed with the display unit are moved to the right and left.

In this manner, the display device includes the IPD adjusting mechanism based on the shaft units one in the upper portion and one in the lower portion. As a result, the display device can implement a robust mechanism against rotation and displacement.

The moving mechanism includes two shafts fixed to the upper portion of the casing, and the bearings corresponding to the shafts fixed to the upper portion of the display unit, and the bearings slide to the right and left with respect to the direction in which the bearings directly face the casing, so that the display unit and the camera integrally formed with the display unit are moved to the right and left.

In this manner, the display device has the structure in which the shaft unit is provided only in the upper portion, so that it is possible to implement a clear appearance in which unnecessary structural parts do not enter the user's visual field.

The moving mechanism includes one shaft fixed to the upper portion of the casing, and the bearing corresponding to the shaft fixed to the upper portion of the display unit, and the bearing slides to the right and left with respect to the direction in which the bearing directly faces the casing, so that the display unit and the camera integrally formed with the display unit are moved to the right and left, and the moving mechanism further includes the mechanism of suppressing the rotation about the right-and-left moving direction.

In this manner, the display device has a structure with reduced components and excellent design, and can also suppress unnecessary rotation of the optical block.

The calculation unit calculates a difference in coordinates between the corresponding feature points in the stereo image obtained by the plurality of cameras. The conversion unit translates the image displayed on the display unit to either the right or left on the basis of the difference between the coordinates.

In this manner, the display device can correct not only the vertical displacement but also the displacement in the right-and-left direction. By this, the display device can implement more appropriate binocular stereoscopic vision.

### (4. Hardware Configuration)

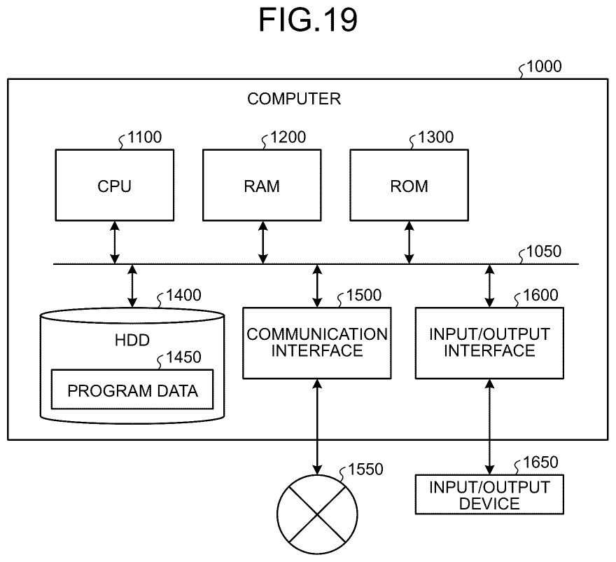

The information device such as the display device 100 according to each embodiment described above is implemented by a computer 1000 having a configuration as illustrated in FIG. 19, for example. Hereinafter, it is described with the display device 100 according to the embodiment as an example. FIG. 19 is a hardware configuration diagram illustrating an example of the computer 1000 that implements functions of the display device 100. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000 and the like.

The HDD 1400 is a computer-readable recording medium that non-transiently records a program executed by the CPU 1100, data used by the program and the like. Specifically, the HDD 1400 is a recording medium that records a display program according to the present disclosure as an example of program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a keyboard and a mouse via the input/output interface 1600. The CPU 1100 also transmits data to an output device such as a display, a speaker, or a printer via the input/output interface 1600. The input/output interface 1600 may function as a medium interface that reads a program and the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory or the like.

For example, in a case where the computer 1000 functions as the display device 100 according to the embodiment, the CPU 1100 of the computer 1000 implements the functions of the control unit 130 and the like by executing the display program loaded on the RAM 1200. The HDD 1400 stores the display program according to the present disclosure and data in the storage unit 120. Note that, the CPU 1100 reads the program data 1450 from the HDD 1400 to execute, but as another example, these programs may be acquired from another device via the external network 1550.

Note that, the present technology can also have the following configurations.

(1) A display device comprising:
a calculation unit that calculates a displacement of a baseline serving as a reference of display processing on right and left display units on the basis of information obtained from a plurality of cameras installed in the vicinity of the right and left display units corresponding to a user's visual field; and
a conversion unit that converts an image displayed on the display unit so as to correct the baseline displacement calculated by the calculation unit.

(2) The display device according to (1), wherein
the calculation unit calculates the baseline displacement on the basis of correspondence of feature points in a stereo image obtained by the plurality of cameras.

(3) The display device according to (2), wherein
the calculation unit calculates the baseline displacement on the basis of correspondence of feature points obtained by feature point detection with respect to an object included in the stereo image.

(4) The display device according to any one of (1) to (3), wherein
the conversion unit converts the image displayed on the display unit using a rotation matrix and a vertical offset set so that the baseline displacement calculated by the calculation unit is minimized.

(5) The display device according to claim 4, wherein
the conversion unit converts the image displayed on the display unit on the basis of a parameter with which an arrangement displacement between the display unit and a camera is corrected.

(6) The display device according to any one of (1) to (5), further comprising:
an output unit that outputs the image converted by the conversion unit to each of the right and left display units.

(7) The display device according to any one of (1) to (6), further comprising:
an optical block including the display unit, the camera, and a moving mechanism that slides the display unit to the right and left with respect to a direction in which the display unit directly faces a casing; and
the casing to which the optical block is attached.

(8) The display device according to (7), wherein
the moving mechanism includes: one shaft fixed to each of an upper portion and a lower portion of the casing; and a bearing corresponding to the shaft and fixed to each of an upper portion and a lower portion of the display unit, and the bearing slides to the right and left with respect to a direction in which the bearing directly faces the casing, so that the display unit and the camera integrally formed with the display unit are moved to the right and left.

(9) The display device according to (7), wherein
the moving mechanism includes: two shafts fixed to an upper portion of the casing; and bearings corresponding to the shafts and fixed to an upper portion of the display unit, and the bearings slide to the right and left with respect to a direction in which the bearings directly face the casing, so that the display unit and the camera integrally formed with the display unit are moved to the right and left.

(10) The display device according to (7), wherein
the moving mechanism includes: one shaft fixed to an upper portion of the casing; and a bearing corresponding to the shaft and fixed to an upper portion of the display unit, the bearing slides to the right and left with respect to a direction in which the bearing directly faces the casing, so that the display unit and the camera integrally formed with the display unit are moved to the right and left, and the moving mechanism further includes a mechanism that suppresses rotation about a right-and-left moving direction.

(11) The display device according to any one of (1) to (10), wherein
the calculation unit calculates a difference between coordinates of corresponding feature points in a stereo image obtained by the plurality of cameras, and
the conversion unit translates the image displayed on the display unit to each of the right or left on the basis of the difference between the coordinates.

(12) A display method comprising:
by a computer,
calculating a displacement of a baseline serving as a reference of display processing on right and left display units on the basis of information obtained from a plurality of cameras installed in the vicinity of the right and left display units corresponding to a user's visual field; and
converting an image displayed on the display unit so as to correct the calculated baseline displacement.

(13) A display program for causing a computer to function as:
a calculation unit that calculates a displacement of a baseline serving as a reference of display processing on right and left display units on the basis of information obtained from a plurality of cameras installed in the vicinity of the right and left display units corresponding to a user's visual field; and
a conversion unit that converts an image displayed on the display unit so as to correct the baseline displacement calculated by the calculation unit.

### REFERENCE SIGNS LIST

10 EYEGLASS-TYPE CASING
20 UPPER SHAFT UNIT
22 UPPER SHAFT BEARING
24 UPPER SHAFT
30 LOWER SHAFT UNIT
32 LOWER SHAFT BEARING
34 LOWER SHAFT
50 OPTICAL BLOCK
52 OPTICAL PRISM
54 PRISM HOLDER
56 SCREEN DISPLAY PANEL
60 CAMERA
100 DISPLAY DEVICE
110 DISPLAY UNIT
120 STORAGE UNIT
130 CONTROL UNIT
131 PARALLAX CALCULATION UNIT
132 IMAGE CONVERSION UNIT
133 DISPLAY CONTROL UNIT

1. A display device comprising:
a calculation unit that calculates a displacement of a baseline serving as a reference of display processing on right and left display units on the basis of information obtained from a plurality of cameras installed in the vicinity of the right and left display units corresponding to a user's visual field; and
a conversion unit that converts an image displayed on the display unit so as to correct the baseline displacement calculated by the calculation unit.

2. The display device according to claim 1, wherein
the calculation unit calculates the baseline displacement on the basis of correspondence of feature points in a stereo image obtained by the plurality of cameras.

3. The display device according to claim 2, wherein
the calculation unit calculates the baseline displacement on the basis of correspondence of feature points obtained by feature point detection with respect to an object included in the stereo image.

4. The display device according to claim 1, wherein
the conversion unit converts the image displayed on the display unit using a rotation matrix and a vertical offset set so that the baseline displacement calculated by the calculation unit is minimized.

5. The display device according to claim 4, wherein
the conversion unit converts the image displayed on the display unit on the basis of a parameter with which an arrangement displacement between the display unit and a camera is corrected.

6. The display device according to claim 1, further comprising:
an output unit that outputs the image converted by the conversion unit to each of the right and left display units.

7. The display device according to claim 1, further comprising:
an optical block including the display unit, the camera, and a moving mechanism that slides the display unit to the right and left with respect to a direction in which the display unit directly faces a casing; and
the casing to which the optical block is attached.

8. The display device according to claim 7, wherein
the moving mechanism includes: one shaft fixed to each of an upper portion and a lower portion of the casing; and a bearing corresponding to the shaft and fixed to each of an upper portion and a lower portion of the display unit, and the bearing slides to the right and left with respect to a direction in which the bearing directly faces the casing, so that the display unit and the camera integrally formed with the display unit are moved to the right and left.

9. The display device according to claim 7, wherein
the moving mechanism includes: two shafts fixed to an upper portion of the casing; and bearings corresponding to the shafts and fixed to an upper portion of the display unit, and the bearings slide to the right and left with respect to a direction in which the bearings directly face the casing, so that the display unit and the camera integrally formed with the display unit are moved to the right and left.

10. The display device according to claim 7, wherein
the moving mechanism includes: one shaft fixed to an upper portion of the casing; and a bearing corresponding to the shaft and fixed to an upper portion of the display unit, the bearing slides to the right and left with respect to a direction in which the bearing directly faces the casing, so that the display unit and the camera integrally formed with the display unit are moved to the right and left, and the moving mechanism further includes a mechanism that suppresses rotation about a right-and-left moving direction.

11. The display device according to claim 1, wherein
the calculation unit calculates a difference between coordinates of corresponding feature points in a stereo image obtained by the plurality of cameras, and
the conversion unit translates the image displayed on the display unit to each of the right or left on the basis of the difference between the coordinates.

12. A display method comprising:
by a computer,
calculating a displacement of a baseline serving as a reference of display processing on right and left display units on the basis of information obtained from a plurality of cameras installed in the vicinity of the right and left display units corresponding to a user's visual field; and
converting an image displayed on the display unit so as to correct the calculated baseline displacement.

13. A display program for causing a computer to function as:
a calculation unit that calculates a displacement of a baseline serving as a reference of display processing on right and left display units on the basis of information obtained from a plurality of cameras installed in the vicinity of the right and left display units corresponding to a user's visual field; and
a conversion unit that converts an image displayed on the display unit so as to correct the baseline displacement calculated by the calculation unit.
